(19) United States
(12) Patent Application Publication
(10) Pub. No.: US 2017/0022322 A1
(43) Pub. Date: Jan. 26, 2017

(54) New polymeric materials

(71) Applicant: SOLVAY SPECIALTY POLYMERS USA, LLC, Alpharetta, GA (US)

(72) Inventors: Chantal LOUIS, Alpharetta, GA (US); Mohammad Jamal EL-HIBRI, Atlanta, GA (US); David B. THOMAS, Atlanta, GA (US)

(73) Assignee: SOLVAY SPECIALTY POLYMERS USA, LLC, Alpharetta, GA (US)

(21) Appl. No.: 15/113,203

(22) PCT Filed: Jan. 21, 2015
(86) PCT No.: PCT/EP2015/051153

§ 371 Date: Jul. 21, 2016

Related U.S. Application Data
(60) Provisional application No. 61/930,162, filed on Jan. 22, 2014.

(30) Foreign Application Priority Data
May 6, 2014 (EP) 14167122.2

(51) Int. Cl. C08G 65/40; C08J 5/00

(52) U.S. Cl. CPC C08G 65/4056; C08J 5/00; C08J 2371/10

(57) ABSTRACT

A copolymer essentially consisting of: from 50 to 99 mole % of at least one recurring unit (R₁), based on the total mole amount of the recurring units (R₁) and (R₂), wherein the recurring unit (R₁) is derived from incorporation of 4,4″-terphenyl-p-diol and a dihaloaryl sulfone compound and from 1 to 50 mole % of at least one recurring unit (R₂), based on the total mole amount of the recurring units (R₁) and (R₂), wherein the recurring unit (R₂) is derived from incorporation of 4,4″-terphenyl-p-diol and a dihaloaryl ketone compound.

### CROSS-REFERENCE TO RELATED APPLICATIONS

This application claims priority to U.S. Provisional Application No. 61/930,162 filed on Jan. 22, 2014, and to European Application No. EP 14167122.2 filed on May 6, 2014, the whole content of each of these applications being incorporated herein by reference for all purposes.

### FIELD OF INVENTION

The present invention relates to sulfone/ketone polymeric materials comprising moieties derived from incorporation of 4,4″-terphenyl-p-diol and to a process for the manufacture of said sulfone/ketone polymeric materials.

### BACKGROUND OF THE INVENTION

The selection of polymeric material in more demanding, corrosive, harsh chemical, high-pressure and high-temperature (HP/HT) environments, such as notably in oil and gas downhole applications, in particular in deep see oil wells, is of ultimate importance as it implies that said polymeric materials need to possess some critical properties in order to resist the extreme conditions associated with said environments.

It should be mentioned that in these extreme conditions the polymeric materials are exposed in a prolonged fashion to high pressure, e.g. pressures higher than 30,000 psi, high temperatures, e.g. temperatures up to 200° C. or higher, and to harsh chemicals including acids, bases, superheated water/steam, and of course a wide variety of aliphatic and aromatic organics. For example, enhanced oil recovery techniques involve injecting of fluids such as notably water, steam, hydrogen sulfide (H₂S) or supercritical carbon dioxide (sCO₂) into the well. In particular, sCO₂ having a solvating effect similar to n-heptane, can cause swelling of materials in for instance seals, which affect consequently their performance. Polymeric materials having too low glass transition temperatures (Tg) relative to the high temperature in HP/HT applications will suffer from being weak and susceptible to high creep in these HP/HT applications. This creep can cause the seal material made of said polymeric material to no longer effectively seal after prolonged exposure at temperature which are 20 or more ° C. above their Tg.

Thus, properties such as maintaining mechanical rigidity and integrity (e.g. yield/tensile strength, hardness and impact toughness) at high pressure and temperatures of at least 200° C., good chemical resistance, in particular when exposed to CO₂, H₂S, amines and other chemicals at said high pressure and temperature, swelling and shrinking by gas and by liquid absorption, decompression resistance in high pressure oil/gas systems, gas and liquid diffusion and long term thermal stability need to be considered in the selection of appropriate polymeric materials for HP/HT applications.

Thus said polymeric materials need at least to possess a high glass transition temperature.

Commercially available semi-crystalline polyarylene ether ketone (PAEK) polymers are exhibiting excellent chemical resistance but are limited by their low glass transition temperatures (Tg) (145° C. for polyether ether ketone (PEEK), 170° C. for polyether ketoneetherketoneketone (PEKEKK)). Polyarylene ether ketone (PAEK) polymers having higher Tg of above 200° C. are PAEK exhibiting very high melting temperature (Tm >420° C.) which limits their applicability.

The utility of aromatic sulfone ether polymers in applications combining high thermal and chemical exposure has been limited due to the fact that said aromatic sulfone ether polymers are large amorphous materials and are therefore very limited in their chemical resistance. Semi-crystalline aromatic sulfone ether polymers are extremely rare.

Staniland reports notably in Table 1 of Polymer Preprints, American Chemical Society, Division of Polymer Chemistry, 1992, 33(1), pages 404-405, some crystalline polyethersulphone polymers having high transition glass temperatures (Tg) of above 200° C. and having melting temperatures of below 400° C. (e.g. Structures 1-4 and 7). The author is in particular referring to the polyethersulphone polymer of structure 4, i.e. a sulfone homopolymer, described therein (i.e. —OØØØOØSO₂Ø-, being understood that Ø is Ph or a phenyl group) derived from 4,4′ dichlorodiphenyl sulfone (DCDPS) and dihydroxyterphenylene, which has a Tg of 251° C. and a Tm of 359° C. Said polyethersulphone polymer of structure 4 was already earlier disclosed by the same author in Bulletin des Societes Chimiques Belges, 1989, 98 (9-10), pages 667-676. FIG. 6 of this paper shows notably a DSC (differential scanning calorimetry) scan of the polyethersulphone polymer of structure 4.

Said polyethersulphone polymer of structure 4 also disclosed in EP 0 383 600 A2, in particular, examples 1 and 2 describe the reaction of dichlorodiphenylsulfone (DCDPS, e.g. example 1) or difluorodiphenylsulfone (DFDPS, e.g. example 2) with 4,4″-terphenyl-p-diol (i.e. HO-Ph-Ph-Ph-OH, also called 4,4″-dihydroxyterphenylene). Said aromatic polymers described in example 1, respectively example 2 have a high transition glass temperature (Tg) of 241° C., respectively 251° C., a Tm melting point of 385° C., respectively 389° C., and a reduced viscosity (RV) measured at 25° C. on a solution of 1.0 g of polymer in 100 cm³ H₂SO₄ of 0.27 (dL/g), respectively 1.40 (dL/g).

Staniland also refers in Bulletin des Societes Chimiques Belges, 1989, 98 (9-10), pages 667-676, in particular in Table 3 to a ketone homopolymer derived from 4,4′-difluorobenzophenone and dihydroxyterphenylene. However this ketone homopolymer is described to be too crystalline.

It is known that thermosets due to their three dimensional network of bonds (i.e. cross-linking) are suitable to be used in high temperature applications up to the decomposition temperature. However, one of the drawbacks is that they are more brittle.

In view of all the above, there is still a high need for polymeric materials having glass transition temperatures (Tg) of above 200° C. which can overcome all these drawbacks, as mentioned above, and whereby said polymeric materials are characterized by having improved stiffness and an increased flow while maintaining a good ductility, good chemical resistance, high thermal resistance (e.g. Tg >200° C.), long term thermal stability, and useful highest Tm between 360° C. and 420° C., thus said polymeric materials can be particularly useful in HP/HT applications requiring a very good chemical resistance.

### SUMMARY OF INVENTION

The Applicant has now found that it is possible to advantageously manufacture ketone/sulfone copolymers wherein said copolymers comprise moieties derived from incorporation of 4,4″-terphenyl-p-diol and wherein said copolymers have improved stiffness and an increased flow and are advantageously fulfilling all the above mentioned needs, including maintaining mechanical rigidity and integrity and having in particular good chemical resistance at high pressure and temperature.

It is thus an object of the present invention a copolymer [(P) copolymer, herein after], comprises:
from 50 to 99 mole % of at least one recurring unit (R₁), based on the total mole amount of the recurring units (R₁) and (R₂), wherein the recurring unit (R₁) is selected from the group consisting of those of formulae (Sₜ-1) to (Sₜ-4) herein below:

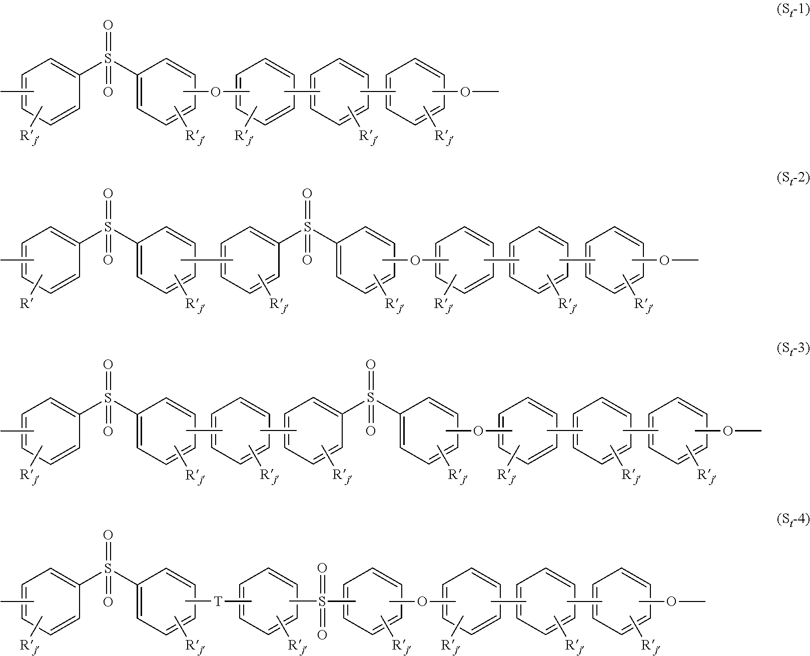

wherein
each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
j′ is zero or is an integer from 1 to 4,
T is a divalent group optionally comprising one or more than one heteroatom;
preferably T is selected from the group consisting of a bond, —CH₂—, —C(O)—, —C(CH₃)₂—, —C(CF₃)₂—, —C(═CCl₂)—, —C(CH₃)(CH₂CH₂COOH)—, and a group of formula:

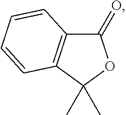

and
from 1 to 50 mole % of at least one recurring unit (R₂), based on the total mole amount of the recurring units (R₁) and (R₂), wherein the recurring unit (R₂) is selected from the group consisting of those of formulae (Kₜ-1) or (Kₜ-2) herein below:

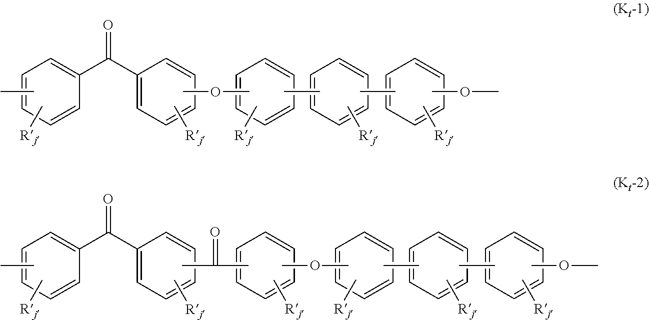

wherein
each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
j′ is zero or is an integer from 1 to 4, and wherein the recurring units (R₁) and (R₂) are present in an amount of more than 75% by mole, based on the total amount of recurring units in (P) copolymer.

Another aspect of the present invention is directed to a process for the manufacturing of the (P) copolymer.

Yet another aspect of the present invention is directed to an article that includes said (P) copolymer.

### DETAILED DESCRIPTION OF EMBODIMENTS

### (P) Copolymer

In recurring unit (R₁), the respective phenylene moieties may independently have 1,2-, 1,4- or 1,3-linkages to the other moieties different from R′ in the recurring unit. Preferably, said phenylene moieties have 1,3- or 1,4-linkages, more preferably they have 1,4-linkage. Still, in recurring units (R₁), j′ is at each occurrence zero, that is to say that the phenylene moieties have no other substituents than those enabling linkage in the main chain of the polymer.

In recurring unit (R₂), the respective phenylene moieties may independently have 1,2-, 1,4- or 1,3-linkages to the other moieties different from R′ in the recurring unit. Preferably, said phenylene moieties have 1,3- or 1,4-linkages, more preferably they have 1,4-linkage. Still, in recurring units (R₂), j′ is at each occurrence zero, that is to say that the phenylene moieties have no other substituents than those enabling linkage in the main chain of the polymer.

Preferred recurring units (R₁) are selected from the group consisting of those of formula (Sₜ′-1) to (Sₜ′-3) herein below:

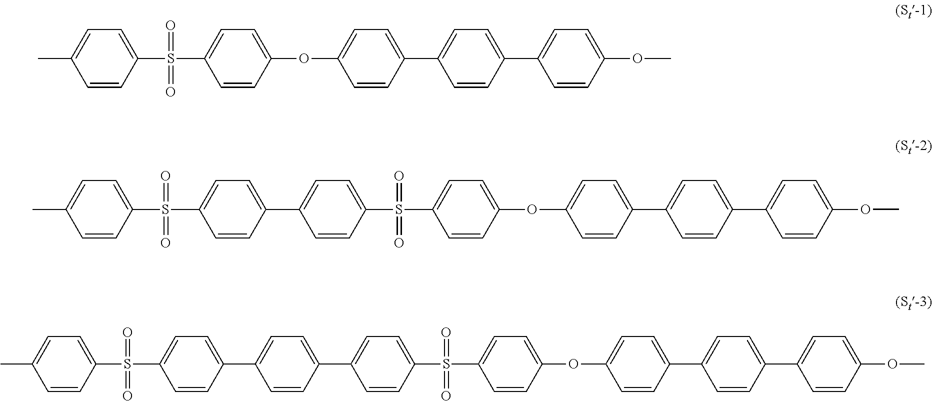

Most preferred recurring unit (R₁) is of formula (Sₜ′-1), as shown above.

More preferred recurring units (R₂) are selected from the group consisting of those of formula (Kₜ′-1), (Kₜ′-2) or (Kₜ′-3), hereinbelow:

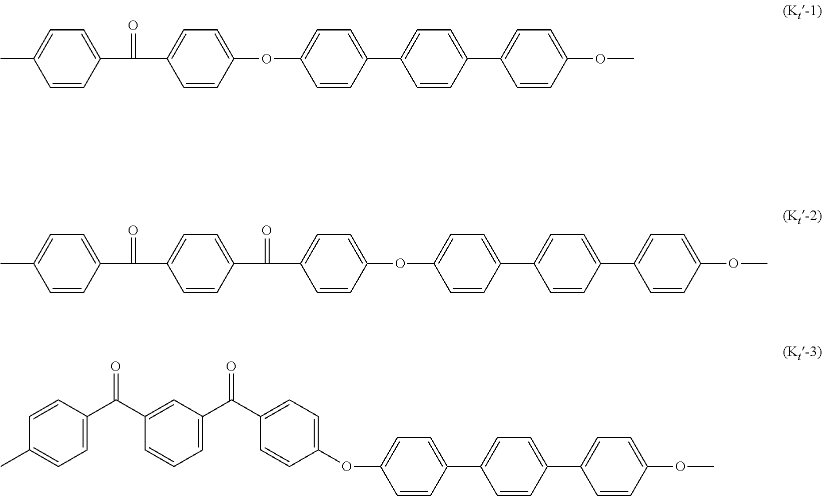

Most preferred recurring unit (R₂) is of formula (Kₜ′-1), as shown above.

The mole amount of the recurring units (R₂) in the (P) copolymer is generally of at least 2%, preferably at least 3%, preferably at least 4%, preferably at least 5%, based on the total amount of recurring units (R₁) and (R₂) comprised in (P) copolymer. It is further understood that the mole amount of the recurring units (R₂) in the (P) copolymer will generally be of at most 48%, preferably at most 45%, more preferably at most 40%, more preferably at most 30%, more preferably at most 20%, and most preferably at most 15%.

Said mole amounts, as described above, can be measured in the (P) copolymer by using standard measuring methods such as notably FT-IR methods and NMR methods.

As said, the (P) copolymer comprises the recurring units (R₁) and (R₂), as above detailed in an amount of more than 75% moles, preferably more than 85% moles, more preferably more than 90% moles, even more preferably more than 95% moles and most preferably more than 98% moles, based on the total amount of recurring units.

Still more preferably, essentially all the recurring units of the (P) copolymer are recurring units (R₁) and (R₂), chain defects, or very minor amounts of other units might be present, being understood that these latter do not substantially modify the properties of the (P) copolymer. Most preferably, all the recurring units of the (P) copolymer are recurring units (R₁) and (R₂). Excellent results were obtained when the (P) copolymer was a copolymer of which all the recurring units are recurring units (R₁) and (R₂), as above detailed.

According to the present invention, the (P) copolymer has advantageously a weight average molecular weight (M_{w}) above 20 000, more preferably above 40 000, more preferably above 50 000, more preferably above 55 000 and most preferably above 60 000.

Upper limit for the weight average molecular weight (M_{w}) of the (P) copolymer is not particularly critical and will be selected by the skilled in the art in view of final field of use.

In one embodiment of the present invention, the (P) copolymer has advantageously a weight average molecular weight (M_{w}) equal to or below 300 000, preferably equal to or below 250 000, preferably equal to or below 230 000, preferably equal to or below 200 000, preferably equal to or below 180 000, preferably equal to or below 170 000, preferably equal to or below 150 000.

In one embodiment of the present invention, the (P) copolymer has advantageously a weight average molecular weight (M_{w}) in the range from 20 000 to 300 000, preferably ranging from 50 000 to 300 000, preferably ranging from 55 000 to 250 000, more preferably from 60 000 to 230 000.

The expression “weight average molecular weight (M_{w})” is hereby used according to its usual meaning and mathematically expressed as:

$${M}_{w} = \frac{\sum {M}_{i}^{2} \cdot {N}_{i}}{\sum {M}_{i} \cdot {N}_{i}}$$

wherein Mᵢ is the discrete value for the molecular weight of polymer molecule, Nᵢ is the number of polymer molecules with molecular weight Mᵢ, then the weight of all polymer molecules is ΣMᵢNᵢ and the total number of polymer molecules is ΣNᵢ.

M_{w} can be suitably determined by gel-permeation chromatography (GPC), calibrated with polystyrene standards.

In a preferred embodiment, the GPC measurements have been carried out according to the procedure as described in our co-pending U.S. Provisional Patent Application.

The (P) copolymer of the present invention has advantageously a polydispersity index (PDI) of more than 1.5, preferably more than 1.7, more preferably more than 1.9.

The (P) copolymer of the present invention has advantageously a polydispersity index (PDI) of less than 4.0, preferably of less than 3.8, preferably of less than 3.5.

The (P) copolymer of the present invention has advantageously a glass transition temperature (Tg) of at least 200° C., preferably at least 210° C., more preferably at least 220° C.

The (P) copolymer may have glass transition temperatures (Tg) of 200° C. to 270° C.

Good results were obtained when the (P) copolymer has a glass transition temperature in the range 210° C. to 260° C.

The glass transition temperature (Tg) may be measured by Differential Scanning calorimetry (DSC) according to ASTM D 3418 Standard.

The (P) copolymer of the present invention advantageously possesses a melting temperature of at least 330° C., preferably 340° C., more preferably at least 350° C. The (P) copolymer of the present invention advantageously possesses a melting temperature below 410° C., preferably below 400° C. and more preferably below 390° C.

The melting temperature (Tm) is generally determined by DSC, according to ASTM D3418.

The Applicant has surprisingly found that the (P) copolymer of the present invention has improved flow characteristics for a given M_{w}, (P) copolymers exhibit a lower melt viscosity than the sulfone homopolymer, as described above, which is advantageous for manufacturing articles by melt process.

In one embodiment of the present invention, the (P) copolymer of the present invention has a melt viscosity of advantageously at least 100 Pa·s, preferably at least 200 Pa·s, more preferably at least 300 kPa·s at 410° C. and a shear rate of 100 rad/sec, as measured using a parallel plates viscometer (e.g. TA ARES RDA3 model) in accordance with ASTM D4440. The (P) copolymer of the present invention has a melt viscosity of advantageously of at most 4 000 Pa·s, preferably of at most 3 500 Pa·s, more preferably of at most 3 000 Pa·s at 410° C. and a shear rate of 100 rad/sec, as measured using a parallel plates viscometer (e.g. TA ARES RDA3 model) in accordance with ASTM D4440.

The (P) copolymer can be a random, an alternate, a block or a graft (P) copolymer.

In a preferred embodiment, the (P) copolymer is a random, or alternate or block (P) copolymer. In a most preferred embodiment, the (P) copolymer is a random (P) copolymer.

### Manufacture of a (P) Copolymer

Although, the method for manufacturing the (P) copolymer of the present invention is not particularly limited, said (P) copolymer can be advantageously prepared by polymerizing the appropriate monomers in conditions suitable for matching the requirements related to the % mole amounts of the recurring units R₁ and R₂, respectively with respect to the total amount of the recurring units R₁ and R₂.

Thus, the invention also pertains to a process for the manufacturing of a (P) copolymer, comprising reacting in a solvent mixture comprising a polar aprotic solvent and in the presence of an alkali metal carbonate, a monomer mixture which contains:
at least one dihydroxyaryl compound [diol (AA), herein after] of formula (T):

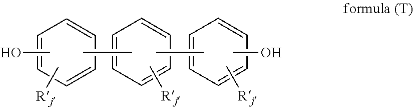

wherein
each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
j′ is zero or is an integer from 1 to 4
at least one dihaloaryl sulfone compound [dihalo(SS), herein after] wherein said dihalo (SS) is selected from the group consisting of those of formulae (S-1) to (S-4), as shown below:

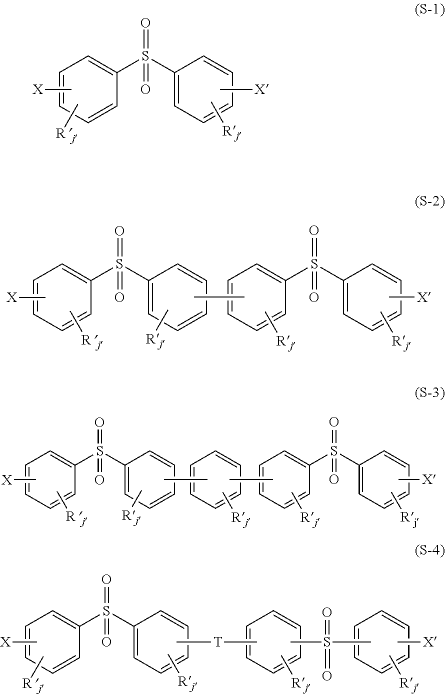

wherein
each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
j′ is zero or is an integer from 1 to 4,
T is a divalent group optionally comprising one or more than one heteroatom; preferably T is selected from the group consisting of a bond, —CH₂—, —C(O)—, —C(CH₃)₂—, —C(CF₃)₂—, —C(═CCl₂)—, —C(CH₃)(CH₂CH₂COOH)—, and a group of formula:

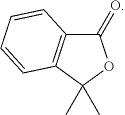

X and X′, equal to or different from each other, are independently a halogen atom, preferably Cl or F;
at least one dihalo aryl ketone compound [dihalo (KK), herein after], wherein said dihalo (KK) is selected from the group consisting of those of formulae (K-1) and (K-2):

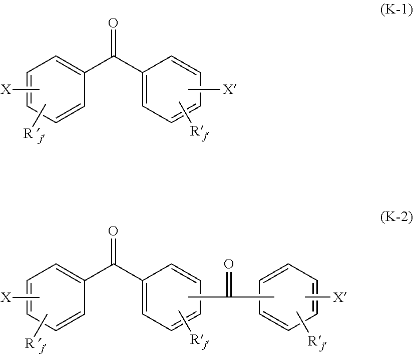

wherein
each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
j′ is zero or is an integer from 1 to 4;
X and X′, equal to or different from each other, are independently a halogen atom, preferably Cl or F;
   being understood that the overall amount of halo-groups and hydroxyl-groups of the monomers of the monomer mixture is substantially equimolecular and wherein the molar amount of the dihalo (KK) relative to the total molar amount of the dihalo (KK) and the dihalo (SS) is at least 1% and at a most 50%.

The molar amount of the dihalo (KK) relative to the total molar amount of the dihalo (KK) and the dihalo (SS) is generally of at least 2%, preferably at least 3%, preferably at least 4%, preferably at least 5%.

The molar amount of the dihalo (KK) relative to the total molar amount of the dihalo (KK) and the dihalo (SS) is generally of at most 48%, preferably at most 45%, more preferably at most 40%, more preferably at most 30%, more preferably at most 20%, and most preferably at most 15%.

Very good results have been obtained when the molar amount of the dihalo (KK) relative to the total molar amount of the dihalo (KK) and the dihalo (SS) is ranging from 3% to 40%.

Excellent results have been obtained when the molar amount of the dihalo (KK) relative to the total molar amount of the dihalo (KK) and the dihalo (SS) is ranging from 3% to 15%.

For the purpose of the present invention, the expression “substantially equimolecular” used with reference to the overall amount of halo-groups and hydroxyl-groups of the monomers initially present at the start of the reaction of the monomer mixture, as above detailed, is to be understood that the molar ratio of the overall amount of hydroxyl groups of the monomers of the monomer mixture to the overall amount of halo groups of the monomers of the monomer mixture is above 0.990, preferably above 0.992, more preferably above 0.995. It is further understood that the molar ratio of the overall amount of hydroxyl groups of the monomers of the monomer mixture to the overall amount of halo groups of the monomers of the monomer mixture is below 1.01, preferably below 1.008, more preferably below 1.005. Good results were obtained when the molar ratio of the overall amount of hydroxyl groups of the monomers of the monomer mixture to the overall amount of halo groups of the monomers of the monomer mixture is about 1.00.

If desired, a small amount of the dihalo(SS), as described above, and/or dihalo (KK), as described above, can be added to the reaction mixture when the reaction is essentially complete.

For the purpose of the present invention, the expression “essentially complete” used with reference to the reaction is to be understood that the amount of all monomers which were initially present at the start of the reaction in the monomer mixture is below 1.5% mol, preferably below 1% mol, relative to the total amount of all monomers which were initially present at the start of the reaction.

Said small amount, expressed in a molar amount with respect to the total amount of moles of the diol (AA), as detailed above is typically in the range from about 0.1 to 15% mol, with respect to the total amount of moles of the diol (AA), as detailed above, preferably from 0.2 to 10% mol, more preferably from 0.5 to 6% mol.

If desired, the solvent mixture can further comprise any end-capping agent [agent (E)]. Said agent (E) is in general selected from the group consisting of a halo compound comprising only one reactive halo group [agent (MX)] and a hydroxyl compound comprising only one reactive hydroxy group [agent (MOH)].

The expression ‘halo compound comprising only one reactive halo group [agent (MX)]’ is intended to encompass not only monohalogenated compounds but also halogenated compounds comprising more than one halo group, but wherein only one of said halo group is reactive.

It is nevertheless generally preferred that said agent (MX) comprises only one halo group.

Thus, agent (MX) is preferably selected from the group consisting of 4-monochlorodiphenylsulfone, 4-monofluorodiphenylsulfone, 4-monofluorobenzophenone, 4-monochlorobenzophenone, alkylchlorides such as methylchloride and the like.

Similarly, the expression ‘hydroxyl compound comprising only one reactive hydroxy group [agent (MOH)]’ is intended to encompass not only monohydroxylated compounds but also hydroxylated compounds comprising more than one hydroxy group, but wherein only one of said hydroxy group is reactive.

It is nevertheless generally preferred that said agent (MOH) comprises only one hydroxy group.

Thus, agent (MOH) is preferably selected from the group consisting of terphenol, phenol, 4-phenylphenol, 4-phenoxyphenol, 4-monohydroxydiphenylsulfone, 4-monohydroxybenzophenone.

In the process of the present invention, the total amount of agent (E), computed as

$$agent ( E ) ( \% moles ) = [ \frac{moles of agent ( MX )}{\begin{matrix}total moles of \\ ( dihalo ( SS ) + dihalo ( KK ) )\end{matrix}} + \frac{moles of agent ( MOH )}{total moles of diol ( AA )} ] \cdot 100$$

is comprised between 0.05 and 20% moles, being understood that the agent (E) might advantageously be agent (MX) alone, agent (MOH) alone or a combination thereof. In other words, in above mentioned formula, the amount of agent (MX) with respect to the total moles of dihalo(SS), as detailed above, and dihalo (KK) as detailed above, can be from 0.05 to 20% moles, the amount of agent (MOH) with respect to the total moles of diol (AA), as detailed above, can be from 0.05 to 20% moles, with the additional provisions that their sum is of 0.05 to 20% moles.

The amount of agent (E), as above described, is of at most 10% moles, preferably at most 8% moles, more preferably at most 6% moles.

The amount of agent (E), as above described, is of at least 0.5% moles, preferably at least 1% moles.

The agent (E) can be present at the start of the reaction in the monomer mixture or/and can be added to the reaction mixture when the reaction is essentially complete.

More preferred dihalo (SS) are those complying with following formulae shown below:

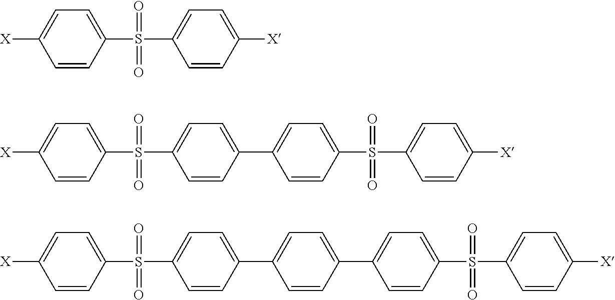

wherein X and X′ are as defined above, X and X′, equal to or different from each other, are preferably Cl or F. More preferably X and X′ are F.

Preferred dihalo (SS) are 4,4′-difluorodiphenyl sulfone (DFDPS), 4,4′-dichlorodiphenyl sulfone (DCDPS), 4,4′-chlorofluorodiphenyl sulfone or a mixture thereof. Most preferred dihalo (SS) is 4,4′-difluorodiphenyl sulfone (DFDPS) or a mixture of DCDPS and DFDPS.

Preferred dihalo (KK) are 4,4′-difluorobenzophenone, 4,4′-dichlorobenzophenone, 4-chloro-4′-fluorobenzophenone, 1,3-bis(4′-fluorobenzoyl)benzene, 1,4-bis(4′-fluorobenzoyl)benzene, and a mixture thereof 4,4′-difluorobenzophenone is particularly preferred.

According to all embodiments of the present invention, the diol (AA), dihalo (SS) and dihalo (KK) are dissolved or dispersed in a solvent mixture comprising a polar aprotic solvent.

As polar aprotic solvents, mention can be made of sulphur containing solvents such as notably aromatic sulfones and aromatic sulfoxides and more specifically diaromatic sulfones and diaromatic sulfoxides according to the general formulae below:

R′—SO₂—R″ or R′—SO—R″

wherein R′ and R″, equal to or different from each other, are independently aryl, alkaryl and araryl groups.

More preferred polar aprotic solvents are those complying with following formulae shown below:

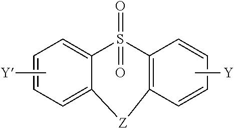

wherein Y and Y′, equal to or different from each other, are independently selected from the group consisting of halogen, alkyl, alkenyl, alkynyl, aryl, alkaryl, aralkyl; Z is a bond, oxygen or two hydrogens (one attached to each benzene ring).

Specifically, among the sulphur-containing solvents that may be suitable for the purposes of this invention are diphenyl sulfone, phenyl tolyl sulfone, ditolyl sulfone, xylyl tolyl sulfone, dixylyl sulfone, tolyl paracymyl sulfone, phenyl biphenyl sulfone, tolyl biphenyl sulfone, xylyl biphenyl sulfone, phenyl naphthyl sulfone, tolyl naphthyl sulfone, xylyl naphthyl sulfone, diphenyl sulfoxide, phenyl tolyl sulfoxide, ditolyl sulfoxide, xylyl tolyl sulfoxide, dixylyl sulfoxide, dibenzothiophene dioxide, and mixtures thereof

Very good results have been obtained with diphenyl sulfone.

Other carbonyl containing polar aprotic solvents, including benzophenone and the like have been disclosed in the art for use in these type of processes, and may also be found useful in the practice of this invention.

If desired, an additional solvent can be used together with the polar aprotic solvent which forms an azeotrope with water, whereby water formed as a by-product during the polymerization may be removed by continuous azeotropic distillation throughout the polymerization.

The by-product water and carbon dioxide possibly formed during the polymerization can alternatively be removed using a controlled stream of an inter gas such as nitrogen or argon over and/or in to the reaction mixture in addition to or advantageously in the absence of an azeotrope-forming solvent as described above.

For the purpose of the present invention, the term “additional solvent” is understood to denote a solvent different from the polar aprotic solvent and the reactants and the products of said reaction.

The additional solvent that forms an azeotrope with water will generally be selected to be inert with respect to the monomer components and polar aprotic solvent. Suitable azeotrope-forming solvents for use in such polymerization processes include aromatic hydrocarbons such as benzene, toluene, xylene, ethylbenzene, chlorobenzene and the like.

The azeotrope-forming solvent and polar aprotic solvent are typically employed in a weight ratio of from about 1:10 to about 1:1, preferably from about 1:5 to about 1:3.

The alkali metal carbonate is preferably sodium carbonate, potassium carbonate, rubidium carbonate and cesium carbonate. Sodium carbonate and especially potassium carbonate are preferred. Mixtures of more than one carbonates can be used, for example, a mixture of sodium carbonate or bicarbonate and a second alkali metal carbonate or bicarbonate having a higher atomic number than that of sodium.

The amount of said alkali metal carbonate used, when expressed by the ratio of the equivalents of alkali metal (M) per equivalent of hydroxyl group (OH) [eq. (M)/eq. (OH)] ranges from 1.00 to 1.50, preferably from 1.00 to 1.30, more preferably from about 1.00 to 1.20, most preferably from about 1.00 to 1.10 being understood that above mentioned hydroxyl group equivalents are comprehensive of those of the diol (AA). Very good results have been obtained with a ratio of eq. (M)/eq. (OH) of 1.01-1.10.

The Applicant has surprisingly found that the use of an optimum amount of alkali metal carbonate allows reducing significantly the reaction times of the process of the present invention while avoiding using excessive amounts of alkali metal carbonate which leads to higher costs and more difficult polymer purifications.

The use of an alkali metal carbonate having an average particle size of less than about 200 μm, preferably of less than about 150 μm preferably of less than about 75 μm, more preferably <45 μm is especially advantageous. The use of an alkali metal carbonate having such a particle size permits the synthesis of the polymers meeting our molecular weight requirements.

If desired, at least one salt (S1) able to react with a fluoride salt (S2) can be added to the reaction mixture. Said fluoride salt (S2) can be formed as one of the by-products during the polymerization reaction when X or/and X′ in dihalo (SS) and/or dihalo (KK) is F. Examples of such fluoride salt (S2) are notably sodium fluoride and potassium fluoride. Suitable salts (S1) for use in such polymerization processes include lithium chloride, calcium chloride and magnesium chloride. It is preferably lithium chloride.

The process according to the present invention is advantageously pursued while taking care to avoid the presence of any reactive gases in the reactor. These reactive gases may be notably oxygen, water and carbon dioxide. O₂ is the most reactive and should therefore be avoided.

In a particular embodiment, the reactor should be evacuated under pressure or under vacuum and filled with an inert gas containing less than 20 ppm of reactive gases, and in particular less than 10 ppm of O₂ prior to adding the alkali metal carbonate to the reaction mixture. Then, the reactor should be put under a constant purge of said inert gas until the end of the reaction. The inert gas is any gas that is not reactive under normal circumstances. It may be chosen from nitrogen, argon or helium. The inert gas contains preferably less than 10 ppm oxygen, 20 ppm water and 20 ppm carbon dioxide.

Generally, after an initial heat up period, the temperature of the reaction mixture will be maintained in a range of advantageously from 250 to 350° C., preferably from 300 to 340° C. Good results were obtained at a temperature at about 320° C.

In one embodiment of the process of the present invention, the alkali metal carbonate, in particular potassium carbonate is added to the monomer mixture at a temperature from 25 to 280° C., preferably from 120 to 270° C., more preferably from 180 to 250° C.

In a more preferred embodiment of the process of the invention, the alkali metal carbonate, in particular potassium carbonate is first added to the diol (AA), as described above, in the solvent mixture, as described above, and the dihalo (SS), as detailed above and the dihalo (KK), as detailed above, is then added to said reaction mixture at a temperature from 25 to 280° C., preferably from 120 to 270° C., more preferably from 180 to 250° C. If desired, the dihalo(SS) and the dihalo(KK) can be added separately and sequentially in order to produce block copolymers instead of random copolymers.

In general, the end-capping agent, as described above, is added to the reaction mixture, as described above, at a temperature from 250 to 350° C., preferably from 300 to 340° C.

The (P) copolymer of the present invention can notably be used in HP/HT applications.

As per the processing, the (P) copolymer of the present invention, can be advantageously processed for yielding articles by melt processing (including injection moulding, extrusion moulding, compression moulding), but also by other processing procedures such as notably spray coating, powder coating selective sintering, fused deposition modelling and the like.

It is another object of the present invention to provide a shaped article comprising the (P) copolymer of the present invention.

The total weight of the (P) copolymer, based on the total weight of the article, is advantageously above 50%, preferably above 80%; more preferably above 90%; more preferably above 95% and more preferably above 99%. If desired, the shaped article may consist of the (P) copolymer.

Should the disclosure of any patents, patent applications, and publications which are incorporated herein by reference conflict with the description of the present application to the extent that it may render a term unclear, the present description shall take precedence.

The invention will be now described in more details with reference to the following examples, whose purpose is merely illustrative and not intended to limit the scope of the invention.

### Raw Materials

1,1′:4′,1″-terphenyl-4,4″-diol commercially available from Yonghi Chemicals, China, further purified by washing with ethanol/water (90/10) at reflux. The purity of the resulting material was shown to be higher than 94.0% area as measured by Gas Chromatography. Said 1,1′:4′,1″-terphenyl-4,4″-diol is including the impurities phenylphenol and biphenylphenol, depending on the efficiency of the purification of the 1,1′:4′,1″-terphenyl-4,4″-diol. The monomer is typically prepared by palladium-catalyzed coupling of 1,4-dibromobenzene and 4-bromomagnesiumanisole (Grignard reagent of 4-bromoanisole), as described in Salunke et al, J. Polym. Sci., Part A: Polymer Chem., 2002, V 40, P 55-69.

4,4′-difluorodiphenylsulfone commercially available from Aldrich (99% grade, 99.32% measured) or from Marshallton (99.92% pure by GC).
4,4′-difluorobenzophenone (DFBP) commercially available from Jintan (99.83%).
Diphenyl sulfone (polymer grade) commercially available from Proviron (99.8% pure).
Potassium carbonate with a d₉₀<45 μm commercially available from Armand products.
Lithium chloride (99+%, ACS grade) commercially available from Acros.

### General Procedure for the Preparation of a (P) Copolymer

In a 500 mL 4-neck reaction flask fitted with a stirrer, a N₂ inlet tube, a Claisen adapter with a thermocouple plunging in the reaction medium, and a Dean-Stark trap with a condenser and a dry ice trap were introduced 89.25 g of diphenyl sulfone, 28.853 g of 1,1′:4′,1″-terphenyl-4,4″-diol and the appropriate amounts of 4,4′-difluorodiphenylsulfone and 4,4′-difluorobenzophenone (as specified in Table 3 below). The flask content was evacuated under vacuum and then filled with high purity nitrogen (containing less than 10 ppm O₂). The reaction mixture was then placed under a constant nitrogen purge (60 mL/min). The reaction mixture was heated slowly to 220° C. At 220° C., 15.354 g of K₂CO₃ were added via a powder dispenser to the reaction mixture over 20 minutes. At the end of the addition, the reaction mixture was heated to 320° C. at 1° C./minute. After the appropriate reaction time at 320° C. (as specified in Table 3 below), 0.559 g of 4,4′-difluorodiphenylsulfone were added to the reaction mixture while keeping a nitrogen purge on the reactor. After 2 minutes, 4.663 g of lithium chloride were added to the reaction mixture. 2 minutes later, another 0.280 g of 4,4′-difluorodiphenylsulfone were added to the reactor and the reaction mixture was kept at temperature for 5 minutes. The reactor content was then poured from the reactor into a stainless steel pan and cooled. The solid was broken up and ground in an attrition mill through a 2 mm screen. Diphenyl sulfone and salts were extracted from the mixture with acetone then water at pH between 12 and 11 then with acetone. The powder was then washed with 1200 mL water containing 2 g of sodium dihydrogen phosphate and 2 g of sodium monohydrogenphosphate. The powder was dried at 120° C. under vacuum for 12 hours yielding a light brown powder (the amount is indicated in Table 3 below). The molecular weights of the final (P) copolymers were measured by GPC, as detailed below and are reported in Table 3. The experimental data are summarized in Table 3.

### Examples 1-5

All these examples were prepared according to the general procedure with different amounts of 4,4′-difluorobenzophenone and 4,4′-difluorodiphenylsulfone and different reaction times (as indicated in Table 2). The molecular weights of the final copolymers were measured by GPC, as detailed below and are reported in Table 3. All experimental data are summarized in Table 3.

### Comparative Example 6

In a 500 mL 4-neck reaction flask fitted with a stirrer, a N₂ inlet tube, a Claisen adapter with a thermocouple plunging in the reaction medium, and a Dean-Stark trap with a condenser and a dry ice trap were introduced 89.25 g of diphenyl sulfone, 28.853 g of 1,1′:4′,1″-terphenyl-4,4″-diol and 27.698 g of 4,4′-difluorodiphenylsulfone. The flask content was evacuated under vacuum and then filled with high purity nitrogen (containing less than 10 ppm O₂). The reaction mixture was then placed under a constant nitrogen purge (60 mL/min).

The reaction mixture was heated slowly to 220° C. At 220° C., 15.354 g of K₂CO₃ were added via a powder dispenser to the reaction mixture over 20 minutes. At the end of the addition, the reaction mixture was heated to 320° C. at 1° C./minute. After 148 minutes at 320° C., 0.5594 g of 4,4′-difluorodiphenylsulfone were added to the reaction mixture while keeping a nitrogen purge on the reactor. After 5 minutes, 4.663 g of lithium chloride were added to the reaction mixture. 10 minutes later, another 0.280 g of 4,4′-difluorodiphenylsulfone were added to the reactor and the reaction mixture was kept at temperature for 15 minutes. The reactor content was then poured from the reactor into a stainless steel pan and cooled. The solid was broken up and ground in an attrition mill through a 2 mm screen. Diphenyl sulfone and salts were extracted from the mixture with acetone then water at pH between 12 and 11 then with acetone. The powder was then washed with 1200 mL water containing 2 g of sodium dihydrogen phosphate and 2 g of sodium monohydrogenphosphate. The powder was then dried at 120° C. under vacuum for 12 hours yielding 48.94 g of a light brown powder. The molecular weight of the resulting polymer was measured by GPC, as detailed below and are reported in Table 3. The experimental data are summarized in Table 3.

The following characterizations carried out on the materials of the Examples are indicated hereinafter:

### Molecular Weight Measurements by a GPC Method

### GPC Condition:

Pump: 515 HPLC pump manufactured by Waters
Detector: UV 1050 series manufactured by HP
Software: Empower Pro manufactured by Waters
Injector: Waters 717 Plus Auto sampler
Flow rate: 0.5 ml/min
UV detection: 270 nm
Column temperature: 40° C.
Column: 2× PL Gel mixed D, 5 micron, 300 mm×7.5 mm 5 micron
manufactured by Agilent
Injection: 20μ liter
Runtime: 60 minutes
Eluent: N-Methyl-2-pyrrolidone (Sigma-Aldrich, Chromasolv Plus for HPLC >99%) with 0.1 mol Lithium bromide (Fisher make). Mobile phase should be stored under nitrogen or inert environment
Calibration standard: Polystyrene standards part number PL2010-0300 manufactured by Agilent was used for calibration. Each vial contains a mixture of four narrow polydispersity polystyrene standards (a total 11 standard, 371100, 238700, 91800, 46500, 24600, 10110, 4910, 2590, 1570, 780 used to establish calibration curve).
Concentration of standard: 1 milliliter of mobile phase added in to each vial before GPC injection for calibration.
Calibration Curve: 1) Type: Relative, Narrow Standard Calibration 2) Fit: 3^{rd} order regression.
Integration and calculation: Empower Pro GPC software manufactured by Waters used to acquire data, calibration and molecular weight calculation. Peak integration start and end points are manually determined from significant difference on global baseline.
Sample Preparation: 25 mg of the (P) copolymer was dissolved in 10 ml of 4-chlorophenol upon heating at 170 to 200° C. A small amount (0.2 to 0.4 ml) of said solution obtained was diluted with 4 ml of N-Methyl-2-pyrrolidone. The resulting solution was passed through to GPC column according to the GPC conditions mentioned above.

### Viscosity Measurements

The melt viscosity was measured on a compression molded disk (25 mm in diameter by 3 mm thickness) with a TA ARES RDA3 Rheometer according to ASTM D4440 using the following conditions:
under nitrogen
410° C.
1 to 100 rad/sec frequency sweep
5% strain

### Physical Property Measurements

DSC measurements were done according to ASTM D3418-03, E1356-03, E793-06, E794-06 on TA Instruments Q20 with nitrogen as carrier gas (99.998% purity, 50 mL/min). Temperature and heat flow calibrations were done using indium. Sample size was 5 to 7 mg. The weight was recorded ±0.01 mg.

The heat cycles were:
1^{st} heat cycle: 50.00° C. to 450.00° C. at 20.00° C./min, isothermal at 450.00° C. for 1 min.
1^{st} cool cycle: 450.00° C. to 50.00° C. at 20.00° C./min, isothermal for 1 min.
2^{nd} heat cycle: 50.00° C. to 450.00° C. at 20.00° C./min, isothermal at 380.00° C. for 1 min.

The glass transition temperature was measured on the polymeric material powder from the 2^{nd} heat thermogram according to the ASTM D3418, by drawing a baseline before the transition and a baseline after the transition: the Tg is the temperature at half height between these two lines.

The melting temperature (Tm melting point) was measured on the polymer powder according to the ASTM D3418: the temperature at which the main melting endotherm is observed in the 1^{st} heat cycle (20° C./min) is the Tm.

### Preparation of Molded and Annealed Plaques:

A 102 mm×102 mm×1.6 mm plaque was prepared from the polymers from examples 1 to 4, and comparative example 6 by compression molding under the following conditions as shown in Table 1 below:

TABLE 1

| Step # | |
|---|---|
| 1 | preheat at 420° C. |
| 2 | 420° C./15 minutes, 50600 kg-f |
| 3 | 420° C./2 minutes, 68200 kg-f |
| 4 | cool down to 320° C. over 20 minutes, 682000 kg-f |
| 5 | 90 minute-hold at 320° C., 68200 kg-f |
| 6 | 25 minute-cool down to 30° C., 50600 kg-f |

The plaque was then annealed at 330° C. for 3 hours under air.

Due to its lower melting point, example 5 was molded under different conditions. A 102 mm×102 mm×1.6 mm plaque was prepared from the polymer from example 4 by compression molding under the following conditions as shown in Table 2 below:

TABLE 2

| Step # | |
|---|---|
| 1 | preheat at 400° C. |
| 2 | 400° C./15 minutes, 50600 kg-f |
| 3 | 400° C./2 minutes, 68200 kg-f |
| 4 | cool down to 300° C. over 20 minutes, 682000 kg-f |
| 5 | 90 minute-hold at 300° C., 68200 kg-f |
| 6 | 25 minute-cool down to 30° C., 50600 kg-f |

The plaque was then annealed at 280° C. for 3 hours under air.

The % crystallinity of molded plaques was determined by measuring the enthalpy of fusion on the first heat scan. The melting of the part was taken as the area over a linear baseline drawn from 40° C. above Tg to a temperature above the last endotherm (typically 420° C.). The crystallinity level of the annealed plaque was determined by comparing the measured melting endotherm to the one of a 100% crystalline material (assumed to 130 J/g). All results are summarized in Table 3.

### Mechanical Property Measurements

### Tensile Properties:

The tensile properties were tested according to ASTM D638 using a Type L impact bars (ASTM D1822, ⅛″×⅜″) as test specimen which were prepared from the annealed plaque, as mentioned above. The tensile properties were measured at 0.05 inch/minute.

### Dynamic Mechanical Analysis (DMA) Measurements of the Molded Plaques

Rectangular test samples (1.2 cm×5.1 cm) were prepared from these molded plaques and were dried at 120° C. under vacuum for 12 hours. Said test samples were then analyzed by Dynamic Mechanical Analysis (DMA) on an TA ARES G2 rheometer under torsion mode (10 rad/sec, 0.05% strain) from 30 to 350° C. at 5.0° C./min, in order to measure the storage (G′) and loss (G″) modulus between 30 and 350° C. The mechanical loss (tan 6) optimum below the melting point (α-transition) which is calculated from the ration of G″ to G′, is reported in Table 3.

All results are summarized in Table 3.

TABLE 3

| | (P) copolymer | | | | | |
|---|---|---|---|---|---|---|
| | Examples (Ex.) | | | | | |
| | | | | | | Comparative |
| | 1 | 2 | 3 | 4 | 5 | example 6 |
| Reaction conditions | | | | | | |
| Molar amount (mol %) of 4,4′- | 3 | 5 | 5 | 10 | 40 | 0 |
| difluorobenzophenone (DFBP) relative to the | | | | | | |
| total mol % of 4,4′-difluorodiphenylsulfone | | | | | | |
| (DFDPS) and 4,4′-difluorobenzophenone (DFBP) | | | | | | |
| DFBP weight (g) | 0.728 | 1.207 | 1.207 | 2.410 | 9.602 | 0 |
| DFDPS weight (g) | 27.329 | 26.574 | 26.574 | 25.171 | 16.922 | 27.968 |
| Reaction time at 320° C. (min) | 82 | 15 | 8 | 8 | 25 | 15 |
| Molecular weight data | | | | | | |
| Mn | 44513 | 37528 | 47173 | 40794 | 15016 | 43711 |
| Mw | 113684 | 135527 | 121421 | 121295 | 55047 | 88130 |
| Mz | 207965 | 288326 | 206086 | 226913 | 143236 | 123923 |
| Mw/Mn (PDI) | 2.55 | 3.61 | 2.57 | 2.97 | 3.67 | 2.02 |
| Mz/Mw | 1.83 | 2.13 | 1.70 | 1.87 | 2.60 | 1.41 |
| MV^{b} (410° C., 100 rad/sec) (Pa * s) | 1118 | N/A | 2654 | 2747 | 1664 | 2500 |
| Physical properties | | | | | | |
| Tg (° C.) | 251 | 251 | 250 | 243 | 213 | 251 |
| Tm (° C.) | 377 | 373 | 369 | 370 | 354 | 370 |
| Crystallinity level (%) | 24 | 25 | N/A | 25 | <10 | 14 |
| Mechanical properties | | | | | | |
| Tensile Strength at yield (psi) | 11800 | no yield | N/A | 12300 | no yield | 11859 |
| Tensile Yield Elongation (%) | 9 | no yield | N/A | 8.2 | no yield | 9.02 |
| Tensile Strength at break (psi) | 9660 | 8580 | N/A | 10800 | 2130 | 9727 |
| Tensile Elongation at Break (%) | 10 | 3.6 | N/A | 17 | 0.46 | 12.4 |
| Young Modulus (Kpsi) | 380 | 381 | N/A | 389 | 474 | 339 |
| tan δ maximum (° C.) | 267 | 265 | N/A | 259 | N/A | 264 |

^{(a)}Experimentally measured by the GPC method, detailed above
^{b}Viscosity measurements were carried out according to ASTM D4440

1-14: (canceled)

15. A copolymer (P) comprising:
from 50 to 99 mole % of at least one recurring unit (R₁), based on the total mole amount of the recurring units (R₁) and (R₂), wherein the recurring unit (R₁) is selected from the group consisting of those of formulae (Sₜ-1) to (Sₜ-4): 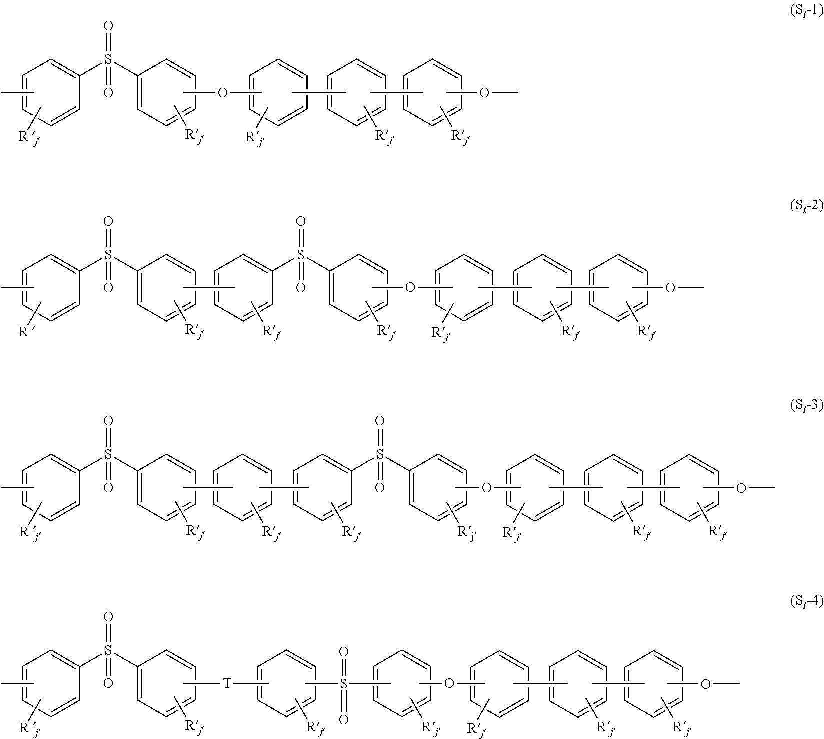
wherein:
each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine, and quaternary ammonium;
j′ is zero or is an integer from 1 to 4;
T is a divalent group optionally comprising one or more than one heteroatom; and
from 1 to 50 mole % of at least one recurring unit (R₂), based on the total mole amount of the recurring units (R₁) and (R₂), wherein the recurring unit (R₂) is selected from the group consisting of those of formulae (Kₜ-1) or (Kₜ-2): 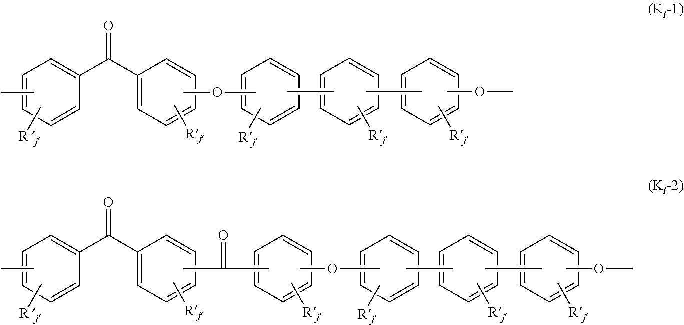
wherein:
each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine, and quaternary ammonium;
j′ is zero or is an integer from 1 to 4; and
wherein the recurring units (R₁) and (R₂) are present in an amount of more than 75% by mole, based on the total amount of recurring units in the copolymer (P).

16. The copolymer (P) according to claim 15, wherein the recurring units are selected from the group consisting of those of formula (Sₜ′-1) to (Sₜ′-3):

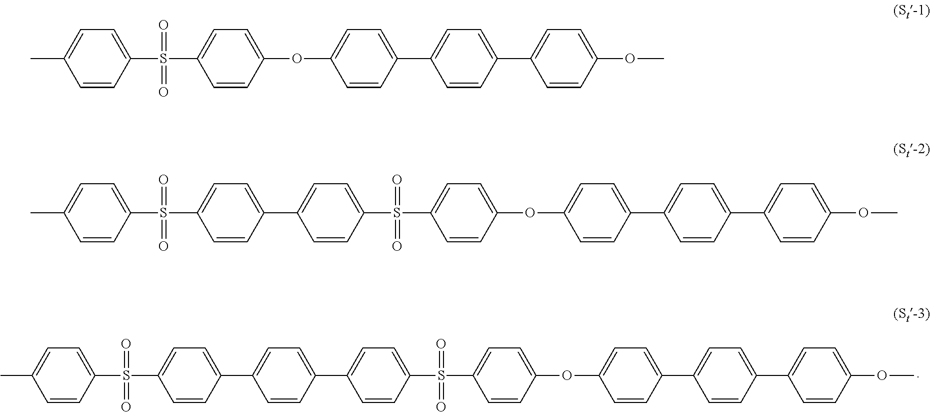

17. The copolymer (P) according to claim 15, wherein the recurring units (R₂) are selected from the group consisting of those of formula (Kₜ′-1), (Kₜ′-2) or (Kₜ′-3):

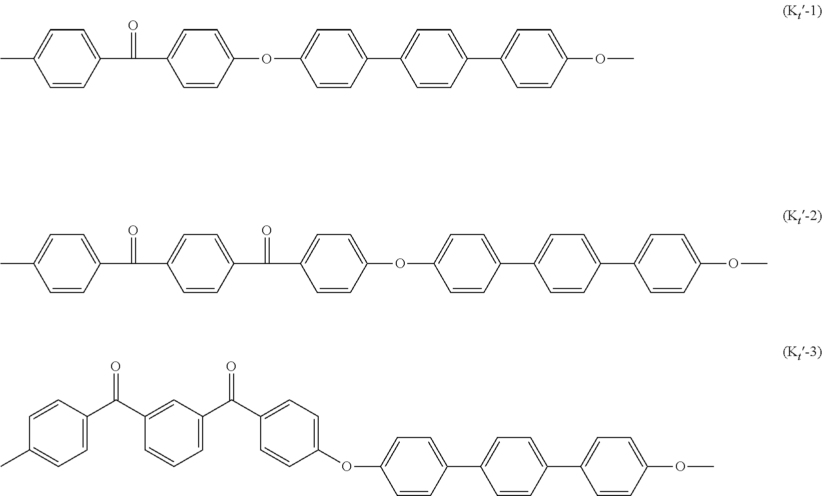

18. The copolymer (P) according to claim 15, wherein the mole amount of the recurring units (R2) is 3 mole % to 50 mole %, based on the total mole amount of recurring units (R1) and (R2).

19. The copolymer (P) according to claim 15, wherein the mole amount of the recurring units (R2) is from 1 mole % to 40 mole %, based on the total mole amount of recurring units (R1) and (R2).

20. The copolymer (P) according to claim 15, wherein the copolymer (P) has a glass transition temperature (Tg) of at least 200° C.

21. The copolymer (P) according to claim 15, wherein the copolymer (P) is a random, an alternate, a block, or a graft copolymer.

22. A process for manufacturing a copolymer (P) comprising reacting in a solvent mixture comprising a polar aprotic solvent and in the presence of an alkali metal carbonate, a monomer mixture comprising:
at least one dihydroxyaryl compound diol (AA) of formula (T): 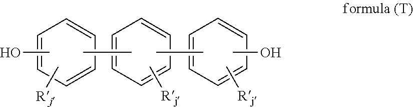
wherein:
each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine, and quaternary ammonium;
j′ is zero or is an integer from 1 to 4;
at least one dihaloaryl sulfone compound (SS) selected from the group consisting of those of formulae (S-1) to (S-4): 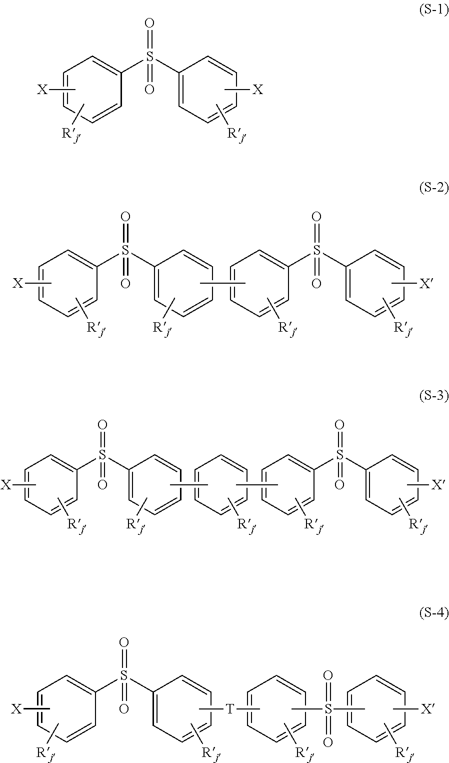
wherein:
each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine, and quaternary ammonium;
j′ is zero or is an integer from 1 to 4;
T is a divalent group optionally comprising one or more than one heteroatom;
X and X′, equal to or different from each other, are independently a halogen atom;
at least one dihaloaryl ketone compound (KK) selected from the group consisting of those of formulae (K-1) and (K-2): 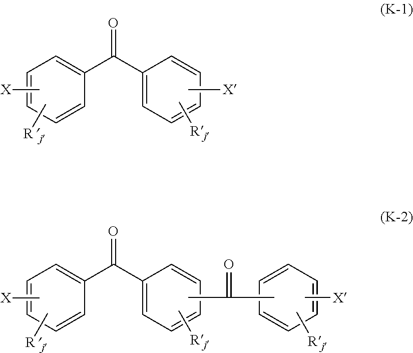
wherein:
each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine, and quaternary ammonium;
j′ is zero or is an integer from 1 to 4;
X and X′, equal to or different from each other, are independently a halogen atom;
wherein the overall amount of halo-groups and hydroxyl-groups of the monomers of the monomer mixture is substantially equimolecular and wherein the molar amount of the dihaloaryl ketone compound (KK) relative to the total molar amount of the dihaloaryl ketone compound (KK) and the dihaloaryl sulfone compound (SS) is 1 mole % to 50 mole %.

23. The process according to claim 22, wherein the molar amount of the dihaloaryl ketone compound (KK) relative to the total molar amount of the dihaloaryl ketone compound (KK) and the dihaloaryl sulfone compound (SS) ranges from 3 mole % to 40 mole %.

24. The process according to claim 22, wherein said dihaloaryl sulfone compound (SS) is 4,4′-difluorodiphenyl sulfone (DFDPS), 4,4′-dichlorodiphenyl sulfone (DCDPS), 4,4′-chlorofluorodiphenyl sulfone, or a mixture thereof.

25. The process according to claim 22, wherein said dihaloaryl ketone compound (KK) is 4,4′-difluorobenzophenone, 4,4′-dichlorobenzophenone, 4-chloro-4′-fluorobenzophenone, 1,3-bis(4′-fluorobenzoyl)benzene, 1,4-bis(4′-fluorobenzoyl)benzene, or a mixture thereof.

26. A method of manufacturing shaped articles, comprising processing the copolymer (P) according to claim 15.

27. The method according to claim 26, wherein the copolymer (P) is processed by melt processing selected from the group consisting of injection moulding, extrusion moulding, or compression moulding, and/or processed by processing procedures selected from the group consisting of spray coating, powder coating selective sintering, or fused deposition modelling.

28. A shaped article manufactured from the copolymer (P) according to claim 15.

29. The copolymer (P) according to claim 15, wherein T is selected from the group consisting of a bond, —CH₂—, —C(O)—, —C(CH₃)₂—, —C(CF₃)₂—, —C(═CCl₂)—, —C(CH₃)(CH₂CH₂COOH)—, and a group of formula:

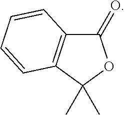

30. The process according to claim 22, wherein T is selected from the group consisting of a bond, —CH₂—, —C(O)—, —C(CH₃)₂—, —C(CF₃)₂—, —C(═CCl₂)—, —C(CH₃)(CH₂CH₂COOH)—, and a group of formula:

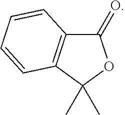

31. The process according to claim 22, wherein X and X′, equal to or different from each other, are Cl or F.
